(19) United States
(12) Patent Application Publication
(10) Pub. No.: US 2014/0175917 A1
(43) Pub. Date: Jun. 26, 2014

(54) ROTOR ASSEMBLY HAVING A COOLANT AGITATION SYSTEM AND METHOD

(71) Applicant: REMY TECHNOLOGIES, L.L.C., Pendleton, IN (US)

(72) Inventor: Paul Martin Dedrich, Auburn, IN (US)

(73) Assignee: REMY TECHNOLOGIES, L.L.C., Pendleton, IN (US)

(21) Appl. No.: 13/722,027

(22) Filed: Dec. 20, 2012

(51) Int. Cl. H02K 9/19

(52) U.S. Cl. CPC H02K 9/19
USPC 310/54

(57) ABSTRACT

A rotor assembly for an electric machine. The rotor assembly includes a shaft that defines a longitudinal axis of the electric machine, and a rotor body including a rotor hub supported by the shaft. The rotor body includes a first axial end and an opposing, second axial end. A coolant agitation system is provided on the rotor body. The coolant agitation system includes one or more coolant agitator members extending from one of the first and second axial ends. Each of the one or more coolant agitator members includes a first section that extends along the longitudinal axis and a second section that extends relative to the first section at a non-zero angle relative to the longitudinal axis.

### BACKGROUND OF THE INVENTION

Exemplary embodiments pertain to the art of electric machines and, more particularly, to an electric machine including a rotor assembly having coolant agitating system.

Many electric machines include cooling systems. The cooling systems take on various forms and are configured to reduce operating temperatures of the electric machine to extend component service life. Electric motors often times will include a cooling system having a rotor or armature driven fan. The fan guides a cooling fluid through the electric motor to dissipate heat. Other cooling systems include passing a fluid through a coolant jacket that surrounds a portion of the electric machine and direct spraying of coolant onto one or more internal components of the electric machine. The liquid coolant may be contained within a sump of the electric machine and pumped through passages formed in or on the rotor.

### BRIEF DESCRIPTION OF THE INVENTION

Disclosed is a rotor assembly for an electric machine. The rotor assembly includes a shaft that defines a longitudinal axis of the electric machine, and a rotor body having a rotor hub supported by the shaft. The rotor body includes a first axial end and an opposing, second axial end. A coolant agitation system is provided on the rotor body. The coolant agitation system includes one or more coolant agitator members extending from one of the first and second axial ends. Each of the one or more coolant agitator members includes a first section that extends along the longitudinal axis and a second section that extends at a non-zero angle relative to the longitudinal axis.

Also disclosed is an electric machine including a housing having an inner surface that defines an interior portion, and a coolant sump provided in the interior portion. A stator is fixedly mounted relative to the inner surface of the housing and a rotor assembly is rotatably mounted relative to the stator. The rotor assembly includes a shaft that defines a longitudinal axis of the electric machine, and a rotor body having a rotor hub supported by the shaft. The rotor body includes a first axial end and an opposing, second axial end. A coolant agitation system is provided on the rotor body. The coolant agitation system includes one or more coolant agitator members extending from one of the first and second axial ends. Each of the one or more coolant agitator members includes a first section that extends substantially along the longitudinal axis and a second section that extends at a non-zero angle relative to the longitudinal axis. At least one of the first and second sections is configured and disposed to agitate a coolant in the sump.

Further disclosed is a method of agitating coolant in an electric machine. The method includes rotating a rotor body relative to a stator. The rotor body includes a coolant agitation system having one or more coolant agitator members. The method further includes guiding the one or more coolant agitator members into a coolant contained within a sump of the electric machine, and agitating the coolant in the sump.

### BRIEF DESCRIPTION OF THE DRAWINGS

The following descriptions should not be considered limiting in any way. With reference to the accompanying drawings, like elements are numbered alike:

FIG. 1 depicts an electric machine including a rotor assembly provided with a coolant agitation system in accordance with an exemplary embodiment;

FIG. 2 depicts a rotor body provided with coolant agitation system of FIG. 1;

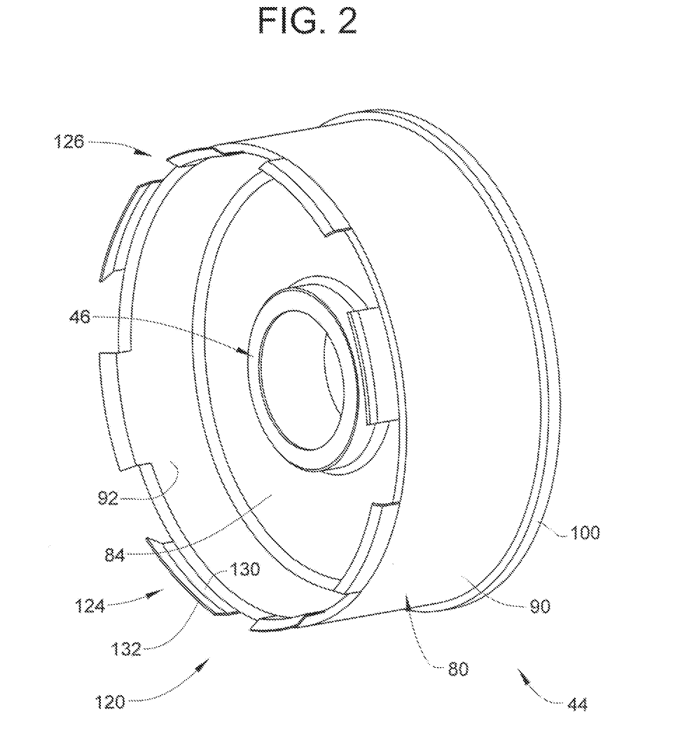

FIG. 3 depicts a rotor body having a coolant agitation system in accordance with another aspect of the exemplary embodiment; and

FIG. 4 depicts a rotor body having a coolant agitation system in accordance with yet another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

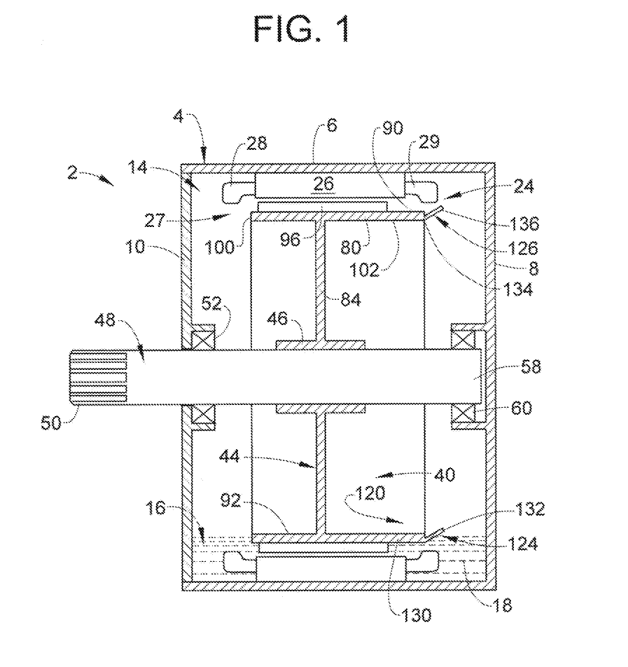

An electric machine in accordance with an exemplary embodiment is indicated generally at 2 in FIG. 1. Electric machine 2 includes a housing 4 having an outer or side wall 6, a first end wall 8, and a second, opposing end wall or cover 10. Housing 4 includes an interior portion 14 having a coolant sump 16. Coolant sump 16 includes an amount of liquid coolant 18 that is passed in a heat exchange relationship with various components of electric machine 2 as will be discussed more fully below.

Electric machine 2 includes a stator assembly 24 mounted to an inner surface (not separately labeled) of side wall 6. Stator assembly 24 includes a stator core 26 that supports a plurality of stator windings 27. Stator windings 27 include a first end turn portion 28 and a second end turn portion 29. Electric machine 2 also includes a rotor assembly 40. Rotor assembly 40 includes a rotor body 44 including a rotor hub 46. Rotor hub 46 receives a shaft 48 having a first end 50 supported at cover 10 through a first bearing 52 and a second end 58 supported at first end wall 8 through a second bearing 60. Shaft 48 defines a longitudinal axis (not separately labeled) of electric machine 2. Rotor body 44 includes a lamination support member 80 supported from rotor hub 46 through a central web 84. Lamination support member 80 includes a radially outward or lamination support surface 90 and a radially inward surface 92. Lamination support surface 90 supports a plurality of rotor laminations indicated generally at 96. Lamination support member 80 includes a first axial end 100 and an opposing second axial end 102.

In accordance with an exemplary embodiment, rotor body 44 includes a coolant agitation system 120 configured to mix, stir, agitate, and/or distribute liquid coolant 18 within interior portion 14. In the exemplary embodiment shown, coolant agitation system 120 includes a first plurality of coolant agitator members, one of which is indicated at 124, and a second plurality of agitator members, one of which is indicated at 126, provided on second axial end 102. Coolant agitator members 124 and coolant agitator members 126 alternate along second axial end 102. In accordance with an aspect of the exemplary embodiment, coolant agitator members 124 and coolant agitator members 126 are materially integrally formed with rotor body 44. However, it should be understood that coolant agitator members 124 and coolant agitator members 126 may be separately formed and secured to rotor body 44 through various joining techniques. Also, it should be understood that while shown on second axial end 102, coolant agitation system 120 may also be provided on first axial end 100, or on both first and second axial ends 100 and 102.

Coolant agitator members 124 include a first section 130 and a second section 132. First section 130 extends from second axial end 102 along the longitudinal axis of electric machine 2. Second section 132 extends radially outwardly from first section 130. In accordance with an aspect of the exemplary embodiment, second section 132 extends radially outwardly from first section 130 at a non-zero angle in a direction generally toward rotor hub 46. Coolant agitator members 126 include a first section 134 and a second section 136. First section 134 extends from second axial end 102 along the longitudinal axis of electric machine 2. Second section 136 extends radially outwardly from first section 134. In accordance with an aspect of the exemplary embodiment, second section 136 extends radially outwardly from first section 134 at a non-zero angle in a direction generally away from rotor hub 46.

Coolant agitator members 124 and 126 pass through liquid coolant 18 in coolant sump 16. Coolant agitator members 124 and 126 stir/mix liquid coolant 18 to enhance heat dissipation. In addition, coolant agitator members 124 and 126 also act as a scoop that captures a portion of liquid coolant 18. The portion of liquid coolant 18 captured by coolant agitator members 124 and 126 flows along rotor body 44 and is directed onto first and second end turn portions 28 and 29 to increase cooling of internal components of electric machine 2.

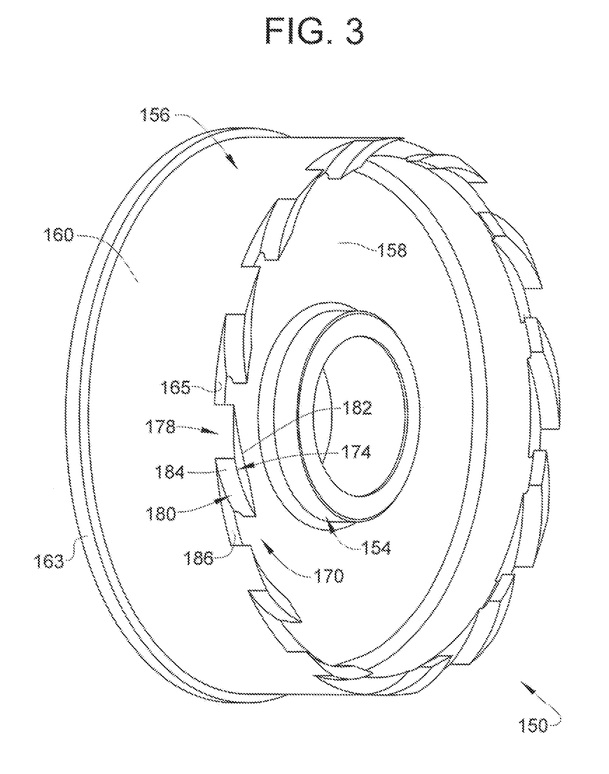

Reference will now be made to FIG. 3 in describing a rotor body 150 in accordance with another exemplary embodiment. Rotor body 150 includes a rotor hub 154 coupled to a lamination support member 156 through a central web 158. Lamination support member 156 includes a lamination support surface 160 configured to support rotor laminations (not shown). Lamination support member 156 also includes a first axial end 163 and a second axial end 165. A coolant agitation system 170 is provided on second axial end 165. Coolant agitation system 170 includes a plurality of coolant agitator members, one of which is indicated at 174. Coolant agitator members 174 include a first section 178 and a second section 180. Second section 180 is formed in first section 178 and includes a radially inward surface 182 and a radial outward surface 184. Radially inward surface 182 and radially outward surface 184 are curvilinear.

In addition, radially inward surface 182 and radially outward surface 184 taper circumferentially forming scoops (not separately labeled). Coolant agitator members 174 are spaced circumferentially about second axial end 165 and separated by a gap 186. In a manner similar to that described above, coolant agitator members 174 stir/mix liquid coolant 18 to enhance heat dissipation. In addition, radially inward surface 182 and radially outward surface 184 capture a portion of liquid coolant 18. The portion of liquid coolant 18 captured by coolant agitator members 174 flows along rotor body 150 and is directed onto first and second end turn portions 28 and 29 to increase cooling of internal components of electric machine 2.

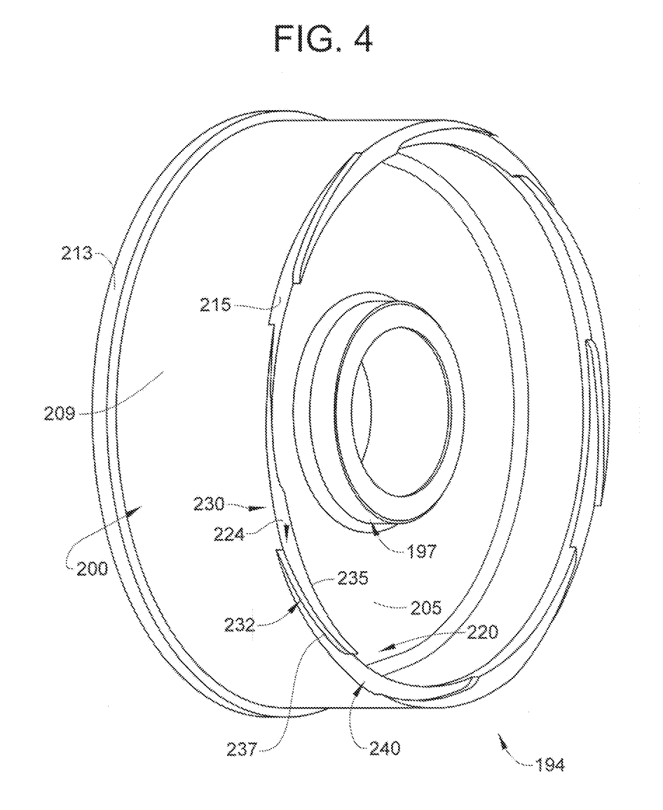

Reference will now be made to FIG. 4 in describing a rotor body 194 in accordance with yet another aspect of the exemplary embodiment. Rotor body 194 includes a rotor hub 197 coupled to a lamination support member 200 through a central web 205. Lamination support member 200 includes a lamination support surface 209 configured to support rotor laminations (not shown). Lamination support member 200 also includes a first axial end 213 and a second axial end 215. A coolant agitation system 220 is provided on second axial end 215. Coolant agitation system 220 includes a plurality of coolant agitator members, one of which is indicated at 224. Coolant agitator members 224 include a first section 230 and a second section 232. Second section 232 is formed in first section 230 and includes a radially inward surface 235 and a radially outward surface 237. Radially inward surface 235 and radially outward surface 237 are curvilinear.

In addition, radially inward surface 235 and radially outward surface 237 taper circumferentially forming scoops (not separately labeled). Coolant agitator members 224 are spaced circumferentially about second axial end 215 and separated by a gap 240. In the exemplary aspect shown, gap 240 is smaller than gap 186 and the number of coolant agitator members 224 is fewer than the number of coolant agitator members 174. In a manner also similar to that described above, coolant agitator members 224 stir/mix liquid coolant 18 to enhance heat dissipation. In addition, radially inward surface 235 and radially outward surface 237 capture a portion of liquid coolant 18. The portion of liquid coolant 18 captured by coolant agitator members 224 flows along rotor body 194 and is directed onto first and second end turn portions 28 and 29 to increase cooling of internal components of electric machine 2.

At this point it should be understood that the exemplary embodiment provides a coolant agitation system that not only agitates liquid coolant in a coolant sump, but also distributes liquid coolant onto internal components of an electric machine. The coolant agitation system includes one or more coolant agitator members provided on an axial end of a rotor body. The coolant agitator members include first and second sections that stir/mix liquid coolant as well as capture a portion of liquid coolant from the coolant sump. The number and shape of coolant agitator members may vary.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment or embodiments disclosed as the best mode contemplated for carrying out this invention, but that the invention will include all embodiments falling within the scope of the claims.

What is claimed is:

1. A rotor assembly for an electric machine comprising:
a shaft that defines a longitudinal axis of the electric machine;
a rotor body including a rotor hub supported by the shaft, the rotor body including a first axial end and an opposing, second axial end; and
a coolant agitation system provided on the rotor body, the coolant agitation system including one or more coolant agitator members extending from one of the first and second axial ends, each of the one or more coolant agitator members including a first section that extends along the longitudinal axis and a second section that extends at a non-zero angle relative to the longitudinal axis.

2. The electric machine according to claim 1, wherein the second section extends radially outwardly from the first section at a non-zero angle relative to a radius of the rotor body.

3. The electric machine according to claim 2, wherein the one or more coolant agitator members includes a plurality of coolant agitator members each having respective first and second sections, wherein the second section of one of the plurality of coolant agitator members extends radially outwardly from the first section in a direction toward the rotor hub, and the second section of another of the plurality of coolant agitator members extends radially outwardly from the corresponding first section in a direction away from the rotor hub.

4. The electric machine according to claim 1, wherein the second section comprises a surface materially integrally formed in the first section.

5. The electric machine according to claim 4, wherein the second section includes a radially outward surface and a radially inward surface.

6. The electric machine according to claim 5, wherein the radially outward surface is curvilinear and the radially inward surface is curvilinear.

7. The electric machine according to claim 4, wherein the second section circumferentially tapers along the first section forming a coolant scoop.

8. An electric machine comprising:
a housing including an inner surface that defines an interior portion, and a coolant sump provided in the interior portion;
a stator fixedly mounted relative to the inner surface of the housing;
a rotor assembly rotatably mounted relative to the stator, the rotor assembly including a shaft that defines a longitudinal axis of the electric machine, and a rotor body including a rotor hub supported by the shaft, the rotor body including a first axial end and an opposing, second axial end; and
a coolant agitation system provided on the rotor body, the coolant agitation system including one or more coolant agitator members extending from one of the first and second axial ends, each of the one or more coolant agitator members including a first section that extends along the longitudinal axis and a second section that extends at a non-zero angle relative to the longitudinal axis, at least one of the first and second sections being configured and disposed to agitate a coolant in the sump.

9. The electric machine according to claim 8, wherein the second section extends radially outwardly from the first section.

10. The electric machine according to claim 9, wherein the second section extends at a non-zero angle relative to a radius of the rotor body.

11. The electric machine according to claim 9, wherein the one or more coolant agitator members includes a plurality of coolant agitator members each having respective first and second sections.

12. The electric machine according to claim 11, wherein the second section of one of the plurality of coolant agitator members extends radially outwardly from the first section in a direction toward the rotor hub, and the second section of another of the plurality of coolant agitator members extends radially outwardly from the corresponding first section in a direction away from the rotor hub.

13. The electric machine according to claim 8, wherein the second section comprises a surface materially integrally formed in the first section.

14. The electric machine according to claim 13, wherein the second section includes a radially outward surface and a radially inward surface.

15. The electric machine according to claim 14, wherein radially outward surface is curvilinear and the radially inward surface is curvilinear.

16. The electric machine according to claim 13, wherein the second section circumferentially tapers along the first section.

17. A method of agitating coolant in an electric machine, the method comprising:
rotating a rotor body relative to a stator, the rotor body including a coolant agitation system having one or more coolant agitator members;
guiding the one or more coolant agitator members into a coolant contained within a sump of the electric machine; and
agitating the coolant in the sump.

18. The method of claim 17, wherein agitating the coolant includes capturing a portion of the coolant on the one or more coolant agitator members and guiding the portion of coolant onto an end turn portion of the stator.

19. The method of claim 17, wherein agitating the coolant includes capturing a portion of the coolant on the one or more coolant agitator members and guiding the portion of coolant onto rotor laminations forming a portion of the rotor body.

20. The method of claim 17, wherein agitating the coolant includes facilitating heat removal from the coolant.
